(19) United States
(12) Patent Application Publication
(10) Pub. No.: US 2005/0254487 A1
(43) Pub. Date: Nov. 17, 2005

(54) Method communication system and communication device for transmitting information

(76) Inventors: Norbert Boll, Munchen (DE); Thomas Gemmer, Munchen (DE); Georg Hein, Munchen (DE); Reiner Kolsch, Isen (DE)

Correspondence Address: Siemens Corporation;Intellectual Property Department, 170 Wood Avenue South, Iselin, NJ, 08830, US

(21) Appl. No.: 10/518,097

(22) PCT Filed: Jun. 4, 2003
(86) PCT No.: PCT/DE03/01869

§ 371 Date: Dec. 14, 2004

(30) Foreign Application Priority Data
Jun. 14, 2002 (DE) 102 26 637.9

(51) Int. Cl. H04L 12/56

(52) U.S. Cl. 370/389

(57) ABSTRACT

Information (cell) that is to be transmitted at least partially via a packet-oriented communication network, e.g. Ethernet (IEEE 802.3) or via a cell-oriented communication network is inserted as useful information into a useful data field of at least one data packet of the communication network, which contains target and useful data respectively, or into a time slot of the time-slot oriented communication network. According to the invention, additional routing information for the transmission is assigned to the information prior to insertion into the data packet or time slot, whereby the information that has been sent with the data packet or time slot to a destination in the packet-or cell-oriented communication network is transmitted in accordance with the respective assigned routing information. The invention permits information cell, cell that is to be transmitted via different connections to be transmitted cost-effectively and transparently via a packet-oriented communication network.

### CROSS REFERENCE TO RELATED APPLICATIONS

This application is the US National Stage of International Application No. PCT/DE03/01869, filed Jun. 4, 2003 and claims the benefit thereof. The International Application claims the benefits of German application No. 10226637.9 filed Jun. 14, 2002, both applications are incorporated by reference herein in their entirety.

### FIELD OF THE INVENTION

The invention relates to a method, communication system and communication device for transmitting information.

### BACKGROUND OF THE INVENTION

In the context of optimizing current communication networks, in particular broadband subscriber access networks (also known simply as access networks) the intention is to provide a large number of subscribers with cost-effective access to broadband services (such as video-on-demand). One option for optimization consists in allocating the equipment and resources provided by the subscriber access networks (e.g. bandwidth and processing speed) to the greatest possible number of subscriber connections. A further cost optimizing option consists in comprehensively centralizing the intelligent functions necessary for current data services in the subscriber access network, which means for example that the subscriber connecting modules arranged in the communication network or in the respective network devices have to be equipped with the minimum functionality.

Furthermore the technological and economic overhead incurred in producing network devices that may be arranged in current communication networks can be reduced by using technologies developed for mass markets (e.g. personal computers) rather than devices specifically developed for broadband subscriber access networks. An example of such a widely used and correspondingly advanced technology is the product developed according to standard IEEE 802.3 known as “Ethernet”, which provides a frame-oriented or packet-oriented and wireless transmission method.

With regard to network devices that may be arranged in current communication networks, such as multiplexer devices (e.g. DSLAM, digital subscriber line access multiplexer), it is known for instance that data cells developed according to the asynchronous transfer mode ATM, which are also known as ATM cells, are switched over a local Ethernet arranged in the network device between subscriber connection modules arranged in the network device and at least one central unit or module having the central functions. Ethernet can be used not only in “hard-wired” (or “backplane”) mode in a rack, for bridging relatively short distances, but also as a wide area communication network for bridging longer distances.

The document “ATM Forum, Technical Committee, Frame-Based ATM Transport over Ethernet (FATE), AF-FBATM-0139.00, February 2000” describes the example of a method by which ATM cells are transmitted over a communication network developed as Ethernet. Disadvantageously the described method is restricted to ATM connections of the AAL 5 type. Therefore this method can be used to only a limited extent in current and future subscriber access networks, since when current data and communication services are produced, ATM cells of all AAL types are transmitted in them, in particular types AAL1 and AAL2. A further disadvantage of this method is that only the useful information of each ATM cell to be transmitted over the Ethernet is inserted in the respective useful data field of the Ethernet frame, which means that the ATM cells to be transmitted require advance processing and thus incur a technical overhead. Transparent transmission of ATM cells over the Ethernet is therefore not possible using known methods.

### SUMMARY OF THE INVENTION

The object of the invention is to improve the transmission of ATM cells over a packet-oriented or time-slot oriented communication network and in particular to create a subscriber access network in which ATM cells having different AAL types and associated with ATM connections that are different at the present time can be transmitted using packet-oriented or time-slot oriented transmission technology, in particular Ethernet transmission technology. This object is achieved by the claims.

According to a first embodiment of the inventive method for transmitting information, the information that is to be transmitted is inserted as useful information (payload) into a useful data field (payload-field) of a minimum of one data packet of a packet-oriented communication network. In addition, target information is inserted into the minimum of one data packet in each case. The important aspect of the inventive method consists in the fact that prior to insertion into the useful data field of the minimum of one data packet, additional routing information for the onward transmission is assigned to the information which is to be transmitted. The minimum of one data packet and the information inserted into it together with the routing information assigned in each case are transmitted to a minimum of one target represented by the target information of the data packet in the packet-oriented communication network. The information transmitted to the minimum of one target is transmitted onwards (i.e. forwarded) in accordance with the routing information assigned in each case.

According to an alternative embodiment of the inventive method, the information that is to be transmitted is inserted as useful information into a minimum of one time slot of a time-slot oriented communication network. The important aspect of the inventive method consists in the fact that prior to insertion into the minimum of one time slot, in each case additional routing information for the onward transmission is assigned to the information which is to be transmitted. The minimum of one time slot and the information inserted into it together with the routing information assigned in each case are transmitted to a minimum of one target in the time-slot oriented communication network. The information transmitted to the minimum of one target is transmitted onwards (i.e. forwarded) in accordance with the routing information assigned in each case.

The important advantage of the inventive method consists in the fact that the originally mentioned disadvantages of the method arising from the FATE standard are avoided.

In contrast to the method described in the standard, the information that is to be transmitted is transferred transparently over the packet-oriented or time-slot oriented communication network, so that the technical and economic overhead incurred in advance processing of the information to be transmitted can be saved. Advantageously, information transmitted transparently over different connections made in the packet-oriented communication network, but via the same target, can be inserted into one or more data packets or time slots of the packet-oriented or time-slot oriented communication network. Furthermore the inventive method is not confined to a specific type of connection, such as AAL type 5 ATM connections. A further advantage is that the high economic and technical overhead incurred at the respective target in the packet-oriented communication network in order to store the additional routing information needed for forwarding the information—for instance for “policing” and “queuing”—is not necessary.

According to an advantageous embodiment of the inventive method, the information transmitted to the target in the packet-oriented or time-slot oriented communication network is replicated according to the routing information and the replicated information is then forwarded. This advantageous embodiment enables the information transmitted to the target to be forwarded almost simultaneously or in parallel, to a plurality of subscribers for example—thereby producing multicast or broadcast connections in the subscriber's direction.

Advantageously the packet-oriented communication network is designed to standard IEEE 802.3. Such communication networks based on Ethernet technology are designed for the mass market in local area networks (LANs) and are therefore cost-optimized. Using Ethernet technology, communication networks arranged locally in a networking or communication device can be used as cost-effective hard wiring for modules of the “backplane” type.

Further advantageous embodiments of the inventive method together with a communication system and a communication device for carrying out the inventive method will emerge from dependent claims.

### BRIEF DESCRIPTION OF THE DRAWINGS

The inventive method will be explained in greater detail with reference to a plurality of drawings in which

FIG. 1 shows an application scenario incorporated in a subscriber access network in which the inventive method is used,

FIG. 2 shows an ATM cell extended according to the inventive method with additional, assigned routing information,

FIG. 3 shows two frame formats defined according to the Ethernet standard IEEE 802.3,

FIG. 4 shows an Ethernet frame formed according to the inventive method, into which extended ATM cells have been inserted.

### DETAILED DESCRIPTION OF THE INVENTION

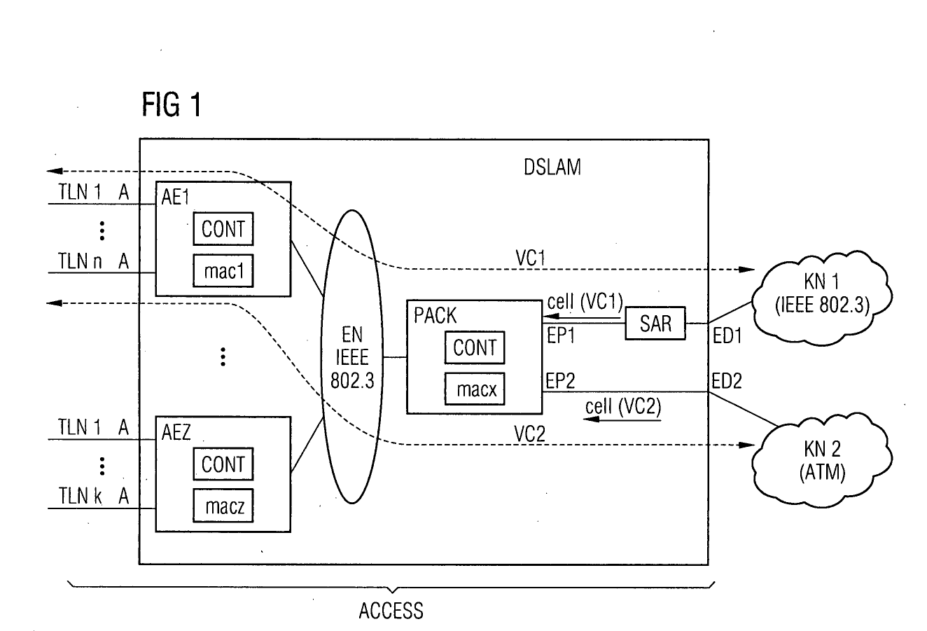

FIG. 1 shows a communication device or multiplexer device DSLAM which has been arranged in a subscriber access network or access network ACCESS designed according to the asynchronous transfer mode ATM, and to which the respective subscribers (not shown) are connected via a plurality of connection units AE1 to Z and via a plurality of subscriber connection lines TLN1 to N or TLN1 to K. Arranged in the communication device DSLAM is a packet-oriented communication network EN (from here on also known as “Ethernet”) which is designed according to IEEE standard 802.3 and over which the respective connection units AE1 to AEZ are internally interconnected. A further unit PACK arranged centrally in the communication device DSLAM is connected to the Ethernet EN. An Ethernet MAC address mac1 to x to z is assigned to each of the connection units AE1 to Z and to the central unit PACK to identify each of these unambiguously within the Ethernet EN (MAC—medium access control).

The central unit PACK is connected to a first input ED1 of the communication device DSLAM via a first input EP1 and via a unit SAR for performing segmentation and re-assembly functions. A first, higher-level communication network KN1, in this example likewise designed according to IEEE standard 802.3, is connected to this first input ED1.

The central unit PACK located in the communication device DSLAM has a second input EP2 which is connected to a second input ED2 provided for the communication device DSLAM. According to the application scenario, a further higher-level communication network KN2 designed according to the asynchronous transfer mode ATM is connected to this second input ED2.

The subscribers connected to the communication device DSLAM are connected via the respective connection units AE1 to z, via the Ethernet EN and via the central unit PACK to both the higher-level communication networks KN1, 2. Control devices CONT for carrying out the inventive method are provided in each of the respective connection units AE1 to z and the central unit PACK.

For the embodiment and example shown in FIG. 1 it is assumed that starting from an outgoing communication device (not shown) in the first communication network KN1, information is transmitted via a virtual connection (indicated in FIG. 1 by a double-headed arrow with a broken line vc1), via the central unit PACK and via the first connection unit AE1 to a communication device (not shown) connected to the first subscriber connection line TLN1. It is further assumed that starting from a communication device located in the second communication network KN2, information is transmitted via a second virtual connection (indicated in FIG. 1 by a double-headed arrow with a broken line vc2), via the central unit PACK and via the first connection unit AE1 to a communication device (not shown) connected to the n-th subscriber connection line TLNn. The information transmitted according to the Ethernet transmission method from the first communication network KN1 to the communication device DSLAM is transmitted to the SAR device via the first input ED1. The transmitted information is segmented and converted into ATM cells by functions arranged in the SAR unit using known SAR methods. The ATM cells cell (vc1) formed in this way are forwarded to the first input EP1 of the central unit PACK. The information or ATM cells cell (vc2) transmitted from the second communication network KN2 are transmitted directly via the second input ED2 of the communication device DSLAM to the second input EP2 of the central unit PACK.

It should be noted that any flow of data or information from differently designed communication networks can be presented to the communication device DSLAM and, after being pre-processed as necessary by the SAR unit, can then be forwarded in the context of the inventive method.

The inventive method will now be described in greater detail.

The method to which the invention relates is based on the originally mentioned Frame-based ATM over Ethernet standard (FATE) from the ATM Forum. However, in contrast to the method described in this standard, complete ATM cells (i.e. having a target data field and a useful data field) with a 53 byte data volume are transmitted, and can be assigned to different virtual connections—in this case vc1, 2. Furthermore the inventive method is not confined to AAL type 5. According to the invention, the ATM cells which occur at the communication device DSLAM or at the inputs EP1, 2 of the central unit PACK and have to be forwarded to the subscribers connected to the communication device DSLAM are inserted by the control or insertion device CONT into the useful data field (or payload field) of an Ethernet frame of the Ethernet EN located in the communication device DSLAM. An Ethernet frame can contain 1 to n data cells or ATM cells, where the number of inserted ATM cells is limited only by the maximum possible length of an Ethernet frame according to the standard. According to the standard the normal length of an Ethernet frame is defined as 1536 bytes. This length can however be increased in certain applications.

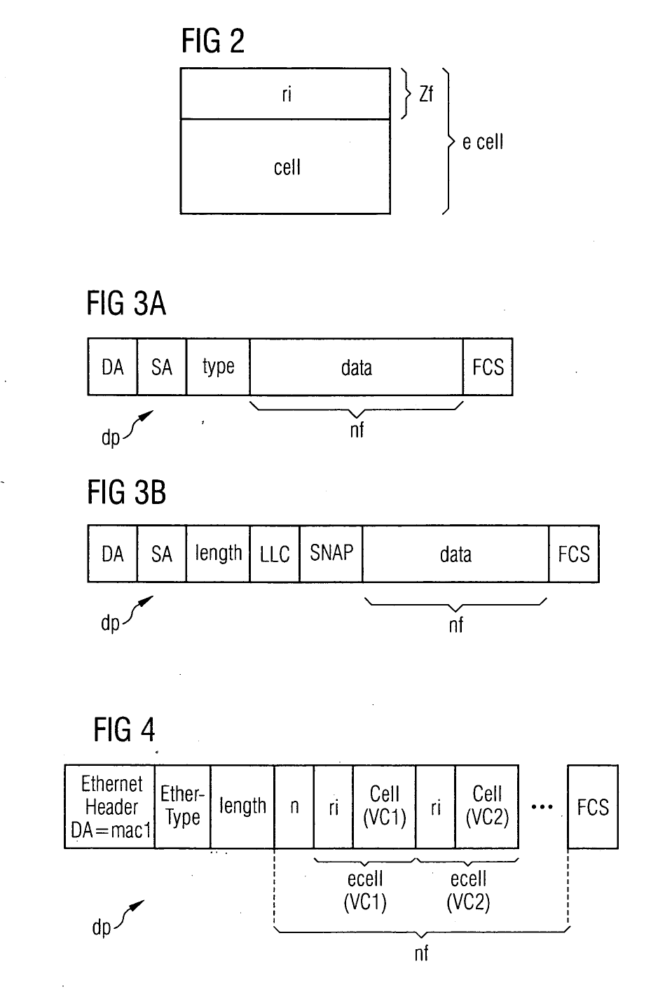

Before insertion into the useful data field of the Ethernet frame, in the context of the method to which the invention relates an additional information field zf for the insertion of the necessary additional routing information ri for the onward transmission of the ATM cells outside the Ethernet is added to each of the ATM cells presented to the two inputs EP1, 2 of the central device PACK. FIG. 2 shows the format of an ATM cell ecell extended in this way. In this embodiment and example, the routing information ri that can be inserted in the additional information field zf identifies a specific subscriber line TLN1 to n, TLN1 to k connected to one of the connection units AE1 to z, or a multicast identification (i.e. a numbering for a multicast or broadcast connection via a plurality of subscriber lines in the direction of the respective subscribers), the routing information ri having in this exemplary embodiment and example a data volume of 8 bits.

Moreover an item of information n representing the number of ATM cells or extended ATM cells ecell inserted in the respective frames dp is additionally entered in the useful data field nf of every Ethernet frame dp.

To identify this type of Ethernet frame which is specially used in the context of the inventive method, a new type identifier—from here on also known as “Ethertype”—is introduced. The introduction of this new “Ethertype” ensures that the Ethernet frames transmitted over the Ethernet EN are correctly processed.

For historical reasons two different frame formats are defined in Ethernet standard IEEE 802.3, the frame format concerned being determined by the value of the first octet following the two address fields or address information items DA, SA (see FIG. 3).

If the value of this octet is greater than 0x0600 (corresponding to the decimal value 1536) this field is interpreted as a type field—shown in FIG. 3a as “type”. The meanings of the individual fields of the frame format dp shown in FIG. 3a are listed below.

Frame Format 1:
DA: the target MAC address (6 octet data volume)
SA: the source MAC address (6 octet data volume)
type: the newly introduced “Ethertype” (value: TBD)”, which defines the format of the next data field nf (2 octet data volume)
data: the payload of the Ethernet frame consisting of:
   1. length identifier n (1 to n extended ATM cells ecell)
   2. n * ATM cells ecell with additional information field zf, i.e. with additional subscriber-line identifier or multicast/broadcast identifier
FCS: the “frame sequence check” (4 octet data volume).

Frame Format 2:

If the value of the octet following both of the address fields DA, SA is less than 0x0600, this field is interpreted as a length specifier for the data following—shown in FIG. 3b as “length”. The individual fields of the data frame dp shown in FIG. 3b have the following meanings:
DA: the target MAC address (6 octet data volume)
SA: the source MAC address (6 octet data volume)
length: the length of the next data field (2 octet data volume)
LLC: the 802.3 header, which specifies an immediately following SNAP header (3 octet data volume)
SNAP: this header identifies the next useful data field nf (5 octet data volume, including the aforementioned “Ethertype” field)
data: the payload of the Ethernet frame dp consisting of:
   1. length identifier n (1 to n ATM cells)
   2. n * ATM cells ecell with additional information field zf, i.e. with additional subscriber-line identifier or multicast/broadcast identifier
FCS: the “frame sequence check” (4 octet data volume).

As explained earlier, the data frames dp shown in FIG. 3 and used in the context of the inventive method are identified as such by the “Ethertype” field. This identifier indicates to the processing routines or control units CONT located in the Ethernet EN that the useful data field nf of the Ethernet frame dp transmitted to the target contains at least one ATM cell cell which must be forwarded according to the routing information ri held in the additional information field zf.

As shown in FIG. 1, the two virtual connections vc1, 2 are made over subscriber connection lines TLN1 to n, which are connected to the same connection unit—in this case AE1. By this means according to the invention a defined number n of the ATM cells cell (vc1), cell (vc2) presented over the two virtual connections vc1, 2 to the central unit PACK can be inserted into the useful data field nf of the Ethernet frame dp to be transmitted over the internal Ethernet EN, such that the first connection unit AE1 is addressed by the target MAC address DA held in the Ethernet frame dp (DA=mac1). An additional information field zf is added to each of the inserted ATM cells cell (vc1), cell (vc2). The respective subscriber connection line over which the respective ATM cell cell (vc1), cell (vc2) is to be transmitted is addressed by this additional information field zf. According to FIG. 1 an item of information identifying the first subscriber connection line TLN1 is inserted in the additional information field zf as switching or routing information ri for the ATM cells cell (vc1) to be transmitted over the first virtual connection vc1 (that is, ri=TLN1). Correspondingly an item of information identifying the n-th subscriber connection line TLNn is inserted in the additional information field zf as switching or routing information ri for the ATM cells cell (vc2) to be transmitted over the second virtual connection vc2 (that is, ri=TLNn).

FIG. 4 shows by way of example the Ethernet frame dp formed according to the above explanations, with ATM cells cell (vc1), cell (vc2), associated in each case with the two virtual connections vc1, 2, inserted into the useful data field nf. It is assumed in this example that the value of the octet (=“Ethertype”) following the two address fields in the Ethernet header is greater than 0x0600, so that the frame format corresponds to the format shown in FIG. 3a. According to FIG. 4 an extended ATM cell ecell (vc1) assigned to the first virtual connection and an extended ATM cell ecell (vc2) assigned to the second virtual connection are inserted appropriately into the useful data field nf of the Ethernet frame dp. It should be noted that in accordance with the Ethernet standard, any number of extended ATM cells that can be assigned to any number of virtual connections can be inserted into the useful data field nf (indicated in FIG. 4 by a broken line), concerning which an item of information n representing the number of inserted ATM cells or inserted, extended ATM cells is inserted into the useful data field nf of the Ethernet frame. Where there are two consecutive Ethernet frames dp, the number n of ATM cells or extended ATM cells inserted in each case into the useful data fields nf of the Ethernet frames dp can be different.

According to the exemplary embodiment, the Ethernet frame dp formed in the central unit PACK is transmitted over the internal Ethernet EN according to the target MAC address held in the Ethernet header (in this case DA=mac1) to the first connection unit AE1. The control unit CONT arranged in the first connection unit AE1 analyses the Ethertype field and detects that the useful data field nf contains extended ATM cells ecell (vc1), ecell (vc2) each of which is to be forwarded according to the routing information in the additional information field zf (in this case ri=TLN1 or ri=TLNn). According to the exemplary embodiment, after removal of the additional information fields zf the ATM cells cell (vc1) associated with the first virtual connection vc1 are forwarded, to or via an output A of the communication device DSLAM and to or via the correspondingly addressed first subscriber connection line TLN1.

It should be noted that according to an alternative embodiment of the inventive method, the respective additional information field zf is not removed before the ATM cells transmitted to the respective target AE1 to z are forwarded. This is the case for example in a cascaded arrangement or system of target connection units (not shown). In this case, after evaluation of the routing information and the respective additional information field, the extended ATM cells are forwarded in a first step, for example to a further module associated with the connection unit. In this module the additional routing information of the transmitted, extended ATM cells is again evaluated in a further step and then, after removal of the additional information fields zf, the ATM cells are forwarded in the manner previously described.

Accordingly, the ATM cells cell (vc2) assigned to the second virtual connection vc2 are forwarded to or via an output A of the communication device DSLAM and to or via the correspondingly addressed n-th subscriber connection line TLNn. The ATM cells cell (vc1), cell (vc2) are then forwarded to or via the access network ACCESS in the subscriber direction according to the ATM transmission method, i.e. in accordance with the VPI and VCI values (virtual path identifier and virtual circuit identifier) contained in the target information of the individual ATM cells.

It should be noted that in addition to the information identifying the appropriate subscriber connection line TLN1 to n or TLN1 to k or the appropriate output port, additional information for the onward transmission can be inserted as routing information ri into the additional information fields zf of the individual, extended ATM cells. For example additional information identifying the ATM service class—VBR, ABR, UBR—assigned to the respective virtual connection or ATM connection, and/or information indicating the QoS (quality of service) can be inserted. The ATM cell concerned is then forwarded in accordance with this additional information, for example to a specific queue of a specific service class type held in the target connection unit, and then via a specific subscriber connection line in the manner described.

In addition to the connection units AE1 to z already described, it is possible to connect to the internal Ethernet EN further connection units located in the communication device DSLAM or central units (not shown), via which only conventional data frames dp formed according to standard IEEE 802.3 (that is, normal Ethernet data traffic) are forwarded to the Ethernet EN. These conventional data frames are transmitted over the Ethernet EN according to standard Ethernet transmission technology together with the data frames or data packets dp formed according to the inventive method.

With the aid of the method to which the invention relates, not only the information cell (vc1), cell (vc2) transmitted via the established connections vc1, vc2, but also further information such as control and configuration data can be advantageously and cost-effectively exchanged between the components such as connection units AE1 to z and central units PACK located in the communication device DSLAM and connected to the Ethernet EN.

1-26. (canceled)

27. A method for transmitting information via a packet-oriented communication network, comprising:
inserting the information that is to be transmitted as payload into a payload-field of a data packet of the packet-oriented communication network;
inserting target information into the data packet;
assigning routing information to the information which is to be transmitted prior to the insertion into the payload-field of the data packet for an onward transmission transmitting the data packet, the information inserted into the data packet, and the assigned routing information to a target represented by the target information of the data packet in the packet-oriented communication network; and
forwarding the information transmitted to the target in accordance with the assigned routing information.

28. The method according to claim 27, wherein the information inserted into the payload-field of the data packet is assigned to at least one virtual connection made at least partially via the packet-oriented communication network.

29. The method according to claim 27, wherein the information transmitted to the target in the packet-oriented communication network is replicated according to the routing information and the replicated information is then forwarded.

30. The method according to claim 27, wherein
the information to be transmitted is a component of at least one data cell of a cell-oriented communication network, wherein
prior to the insertion into the payload-field of the at least one data packet a further information field where the routing information can be inserted is added to the at least one data cell, wherein
the at least one data cell transmitted to the at least one target in the packet-oriented communication network is forwarded to/via the cell-oriented communication network according to the assigned routing information.

31. The method according to claim 30, wherein before the at least one data cell is forwarded to/via the cell-oriented communication network the further information field is removed.

32. The method according to claim 30, wherein an item of information representing the number of data cells inserted into the payload-field of the data packet is inserted into the data packet.

33. The method according to claim 30, wherein the cell-oriented communication network is designed according to the asynchronous transfer mode.

34. The method according to claim 27, wherein the packet-oriented communication network is designed according to the standard IEEE 802.3.

35. The method according to claim 33, wherein the routing information includes further information for identifying an ATM service class.

36. A communication system for transmitting information at least partially via a packet-oriented communication network, wherein the packet-oriented communication network comprises mechanisms for inserting the information as payload into a payload-field of at least one data packet of the packet-oriented communication network, and for inserting target information into the at least one data packet, the communication system comprising:
a mechanism assigned to the insertion mechanisms for assigning additional routing information to the information that is to be inserted into the payload-field of the at least one data packet, wherein
the packet-oriented communication network is designed in such a way that the at least one data packet and the information inserted into it together with the routing information assigned in each case are transmitted to at least one target represented by the target information of the data packet in the packet-oriented communication network, and wherein
at each such target switching mechanisms are provided, by which the information transmitted to the target is forwarded in accordance with the routing information assigned in each case.

37. The communication system according to claim 36, wherein
the information to be transmitted is a component of at least one data cell of a cell-oriented communication network, wherein
the mechanisms for inserting and the mechanisms for assigning are designed in such a way that prior to the insertion into the payload-field of the data packet an additional information field where the routing information can be inserted is added to the at least one data cell, wherein
the switching mechanisms are designed in such a way that the at least one data cell transmitted to the target in the packet-oriented communication network is forwarded to/via the cell-oriented communication network according to the routing information assigned in each case.

38. The communication system according to claim 37, wherein before the at least one data cell is forwarded to/via the cell-oriented communication network the additional information field is removed.

39. The communication system according to claim 37, wherein the switching mechanisms are designed in such a way that an item of information representing the number of data cells inserted into the payload-field of the at least one data packet is inserted into the data packet.

40. The communication system according to one of the claim 37, wherein the cell-oriented communication network is designed according to the asynchronous transfer mode.

41. The communication system according to claim 36, wherein the packet-oriented communication network is designed according to the standard IEEE 802.3.

42. A communication device for transmitting information via a packet-oriented communication network located in the communication device, the communication device having insertion mechanisms for inserting the information that is to be transmitted as payload into a payload-field of at least one data packet of the packet-oriented communication network, and for inserting target information into the at least one data packet, wherein
assignment mechanisms which are assigned to the insertion mechanisms are provided for the purpose of assigning in each case additional routing information to the information that is to be inserted into the payload-field of the at least one data packet, wherein
the communication network is designed in such a way that
the at least one data packet and the information inserted into it together with the routing information assigned in each case are transmitted within the communication device to at least one target represented by the target information of the at least one data packet, and that
in the communication device switching mechanisms assigned to each such target are provided, by which the information transmitted to the target is forwarded in accordance with the routing information assigned in each case.

43. A communication device according to claim 42, wherein
the information to be transmitted is a component of at least one data cell of a cell-oriented communication network, wherein
the insertion mechanisms and the assignment mechanisms are designed in such a way that prior to the insertion into the payload-field of the at least one data packet, an additional information field where the routing information can be inserted is added to the at least one data cell, wherein
the switching mechanisms are designed in such a way that the at least one data cell transmitted to the at least one target in the packet-oriented communication network is forwarded to/via the cell-oriented communication network according to the routing information assigned in each case.

44. A communication device according to claim 43, wherein the switching mechanisms are designed in such a way that before the at least one data cell is forwarded to/via the cell-oriented communication network the additional information field is removed in each case.

45. A communication device according to claim 42, wherein at least one connection unit or central unit located in the communication device and including the respective switching mechanisms is represented by the target information of the at least one data packet.

46. A communication device according to claim 42, wherein the additional routing information represents at least one subscriber connection line connected to the respective connection unit, or at least one connection port assigned to the respective connection unit.

47. A communication device according to claim 43, wherein the cell-oriented communication network is designed according to the asynchronous transfer mode.

48. A communication device according to claim 42, wherein the packet-oriented communication network is designed according to the standard IEEE 802.3.

49. A communication device according to claim 47, wherein the routing information includes information for identifying an ATM service class, wherein a corresponding queue located on the appropriate connection unit is assigned to each ATM service class concerned.
